(19) United States
(12) Patent Application Publication
(10) Pub. No.: US 2025/0290721 A1
(43) Pub. Date: Sep. 18, 2025

(54) Adjustable Headspace Gauge

(71) Applicant: Jeffrey Gent, Brownsville, OR (US)

(72) Inventor: Jeffrey Gent, Brownsville, OR (US)

(21) Appl. No.: 18/607,452

(22) Filed: Mar. 16, 2024

(51) Int. Cl. F41A 31/02; G01B 3/20

(52) U.S. Cl. CPC F41A 31/02; G01B 3/20

(57) ABSTRACT

An headspace gauge has a feature which interfaces with the bolt face of a rifle and a feature which interfaces with the breeching feature of the chamber. The distance between these two features of the gauge is adjustable and is changed until the bolt of the rifle closes with slight difficulty. The gauge is removed and the distance between the two gauge features is measured. The measured value is the headspace dimension, the distance between the bolt face and the breeching feature of the chamber.

### CROSS-REFERENCE TO RELATED APPLICATIONS

Not Applicable

### BACKGROUND OF THE INVENTION

This invention pertains to gunsmithing.

Rifle chamber and ammunition cartridge designations are standardized by the Sporting Arms and Ammunition Manufacturer's Institute (SAAMI). ANSI maintains a corresponding standard Z299.4. These standards define, among other things, the physical dimensions of the cartridge and chamber for each cartridge designation by way of a mechanical drawing specifying the dimensions and tolerances for each feature. Rifle cartridge families are defined by the breeching feature of the cartridge which is the feature of the cartridge that, in conjunction with the bolt face, interfaces with the matching breeching feature of the chamber to position the cartridge in the chamber. Four cartridge breeching features are used: the shoulder, the rim, the belt, or the mouth. For shoulder breeching cartridges the matching breeching feature of the chamber is the shoulder; for rim breeching cartridges the matching breeching feature of the chamber is a face cut in the chamber, for belt breeching cartridges the matching breeching feature of the chamber is a pocket cut in the chamber, and for mouth breeching cartridges the matching breeching feature of the chamber is an edge cut in the chamber.

Headspace is the distance between the bolt face and the breeching feature of the chamber. When the action and barrel are attached to each other adjustments are made to ensure the headspace is within specified tolerances. If the headspace is too small the bolt will not close when a cartridge is loaded into the chamber, if the headspace is too large the bolt will close when a cartridge is loaded but it is has been deemed unsafe to fire the rifle in that condition.

A gunsmith typically uses a pair of headspace gauges to determine whether or not the headspace dimension is within the tolerances defined in the SAAMI specification. Headspace gauges are a single piece of tool steel having a shape reminiscent of a rifle case without the neck or bullet. Among the various features of a headspace gauge is one that interfaces with the bolt face and one that interfaces with the breeching feature of the chamber. The distance between these two features, along with tolerances, is defined by the SAMMI specification. The gunsmith industry makes three different types of headspace gauges commonly referred to as a go gauge, a no-go gauge, and a field gauge. These gauges differ in the distance between the feature that interfaces with the bolt face and the feature that interfaces with the breeching feature of the chamber. For a go gauge the distance between these features is the minimum specified by SAAMI. For a no-go gauge the distance between these features is the maximum specified by SAAMI. Field gauges are not typically used by a gunsmith, they are a variant of the no-go gauge used by the military to determine in the field if a rifle needs to be removed from service. So, for the purposes of this disclosure there are really only two headspace gauges available to the gunsmith, a go gauge and a no-go gauge.

Using gauges in a go/no-go manner is a very old idea that is used throughout industry, it is not unique to gunsmithing. The go/no-go method can be used for inspecting internal or external features of various shapes. Using the inspection of a hole as an example, where the maximum and minimum allowable diameter has been specified, the go gauge will be a pin gauge with a diameter equal to the minimum allowable hole diameter and the no-go gauge will be a pin gauge with a diameter equal to the maximum allowable hole diameter. If the go gauge will go into the hole and the no-go gauge will not go into the hole then the hole diameter is within the allowed range. If the go gauge will not go into the hole the hole diameter is smaller than the allowed minimum. If the no-go gauge goes into the hole then the hole diameter is larger than the allowed maximum. The actual diameter of the hole is not determined by this method.

Similarly, when inspecting headspace a go gauge is inserted into the chamber and the bolt is closed. If the go gauge does not prevent the bolt from closing fully then the distance between the bolt face and the breeching feature of the chamber (the headspace dimension) is not too small. Then the no-go gauge is placed in the chamber and the bolt is closed. If the no-go gauge prevents the bolt from closing fully then the headspace is not too large. If the bolt will not close on the go gauge the headspace is too small. If the bolt will close on the no-go gauge the headspace is too large. This method does not determine the actual value of the headspace dimension, the distance between the bolt face and the breeching feature of the chamber. This is adequate for high volume production but those who build precision rifles have a need to know, with high precision, what the actual headspace dimension is.

### BRIEF SUMMARY OF THE INVENTION

The object of this invention is to provide a gauging tool that can be used to measure the distance between the bolt face and the breeching feature of a rifle chamber, which is called headspace. Disclosed is a gauging tool similar to traditional monolithic go/no-go headspace gauges but with an adjustable connection between the feature of the gauge that interfaces with the bolt face and the feature of the gauge that interfaces with the breeching feature of the chamber.

### BRIEF DESCRIPTION OF THE SEVERAL VIEWS OF THE DRAWING

Drawings have been included that illustrate a traditional go/no-go headspace gauge described above as well as two embodiments of this invention. These drawings present gauges for the most common of the four cartridge types where the breeching feature of the cartridge is the shoulder and the breeching feature of the chamber is the shoulder.

FIG. 1 illustrates the features of a rifle that are relevant to this invention. Rifles come in many forms so for the sake of clarity this is a somewhat idealized representation only showing the common features relevant for this disclosure: the bolt (1), the bolt face (2), the chamber (3), the breeching feature of the chamber (4) (which is a shoulder in this example), and the headspace dimension (5) (for a chamber of the shoulder breeching type). The headspace dimension (5) is from the bolt face (2) to a location approximately in the middle of the breeching feature (4), the specific location is defined by SAAMI.

FIG. 2 illustrates a traditional go/no-go headspace gauge of the shoulder breeching type. For clarity some features of the actual tool have been omitted; included are the body (6), the feature that interfaces with the bolt face (7), the feature that interfaces with the breeching feature of the chamber (8), and the length of the gauge (9).

FIG. 3 is a profile view of the primary embodiment of the invention: an adjustable headspace gauge for a chamber of the shoulder breeching type having a body (10) with a feature that interfaces with the breeching feature of the chamber (14) (a shoulder in this example), and a modified cap screw (11) with a feature that interfaces with the bolt face (12) and a threaded stem (13). For a chamber of the shoulder breeching type the length of the adjustable headspace gauge (15) is measured from the feature that interfaces with the bolt face (12) to a location approximately in the middle of the feature that interfaces with the breeching feature of the chamber (14) (the specific location is defined by SAAMI).

FIG. 4 illustrates an exploded cross sectional view of the embodiment of the invention shown in FIG. 3, showing that the body (10) has a threaded bore (16) along it's central axis within which is a setscrew (17) that is tightened against the threaded stem (13) to lock the position of the modified cap screw (11) thereby fixing the length (15) of the adjustable headspace gauge (10-17).

FIG. 5 illustrates the use of the primary embodiment of the invention. The adjustable headspace gauge (10-17) has been placed inside the chamber (3) after it's length (15) was adjusted such that the feature that interfaces with the bolt face (12) is contacting the bolt face (2) and the feature that interfaces with the breeching feature of the chamber (14) is contacting the breeching feature of the chamber (4). Under these conditions the length (15) of the adjustable headspace gauge (10-17) is the same as the headspace dimension (5) of the chamber (3).

FIG. 6 illustrates a profile view of an alternate embodiment of the invention. Like the primary embodiment this embodiment has a body (18) with a feature that interfaces with the breeching feature of the chamber (22). This embodiment also has a feature that interfaces with the bolt face (20) but unlike the primary embodiment that feature is on a plug (19) having a smooth stem (21).

FIG. 8 illustrates an exploded cross sectional view of the embodiment of the invention illustrated in FIG. 7 showing that another difference between this embodiment and the primary embodiment is that the body (18) has a smooth bore (23).

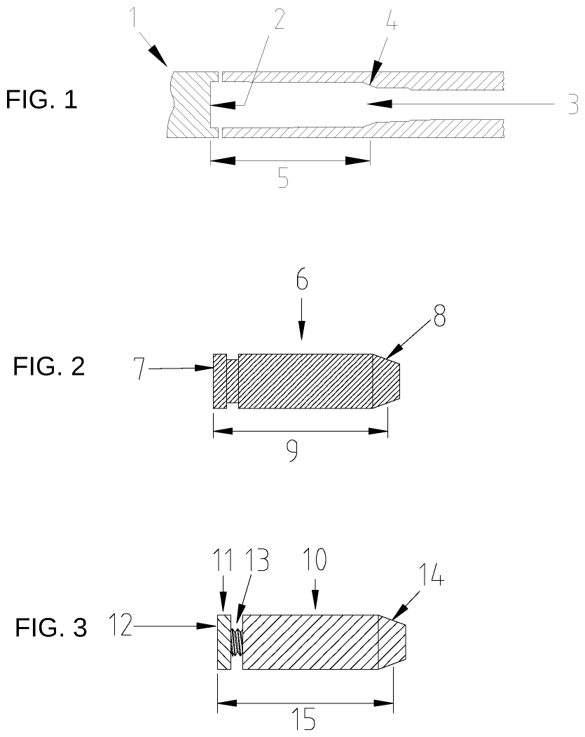

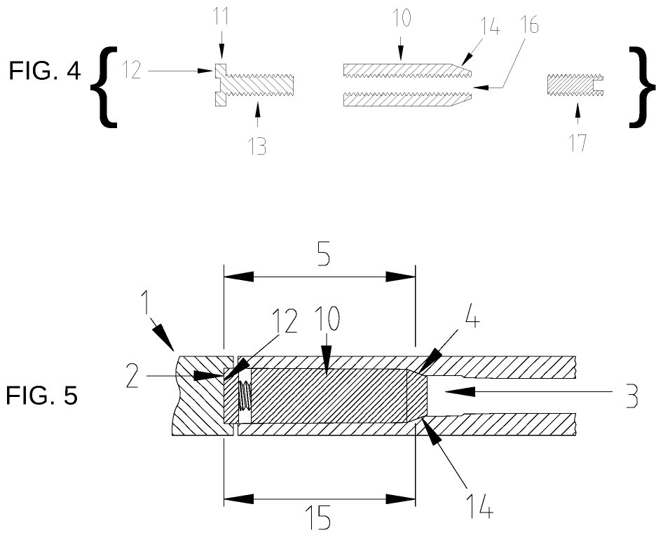

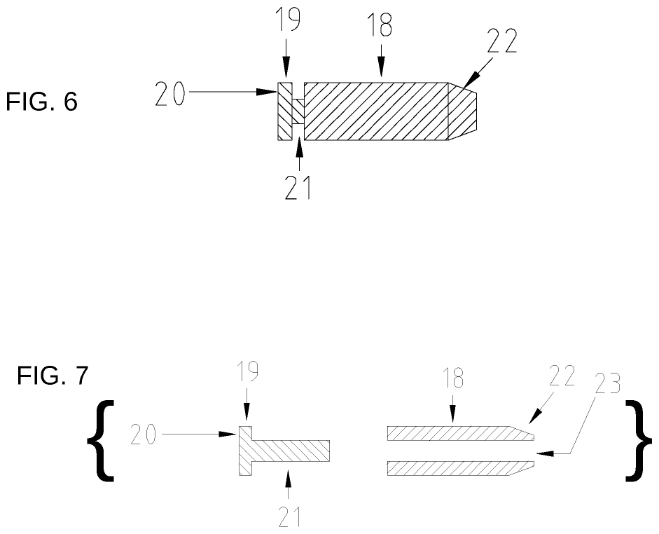

### DETAILED DESCRIPTION OF THE INVENTION

Disclosed is a novel gauging tool that enables precise measurement of headspace, which is the distance (5) between the bolt face (2) and the breeching feature (4) of the chamber (3). This simple instrument provides a headspace gauge (10-17) having an adjustable distance (15) between the feature that interfaces with the bolt face (12) and the feature that interfaces with the breeching feature of the chamber (14) whereby it can be used to determine the headspace distance (5) between the bolt face (2) and the breeching feature of the chamber (4).

This discussion presents an adjustable headspace gauge (10-17) for the most common type of cartridge where the breeching feature is the shoulder and the matching breeching feature of the chamber (4) is also called the shoulder. For shoulder breeching chambers the traditional go/no-go headspace gauge (6-9) is a monolithic piece of tool steel having a feature which interfaces with the bolt face (7) and a feature that interfaces with the breeching feature of the chamber (8), which is a shoulder.

For the primary embodiment of the invention the traditional go/no-go headspace gauge (6-9) is replaced with an adjustable headspace gauge (10-17) comprising a body (10) and a modified cap screw (11) connected by threads (13, 16). The body (10) has a feature (14) that replicates the feature (8) of the traditional go/no-go headspace gauge (6-9) which interfaces with the breeching feature of the chamber (4). The modified cap screw (11) has a feature (12) that replicates the feature (7) of the traditional go/no-go headspace gauge (6-9) which interfaces with the bolt face (2). The adjustable headspace gauge (10-17) is assembled by screwing the threaded stem (13) of the modified cap screw (11) into the threaded bore (16) of the body (10) followed by screwing the setscrew (17) into the threaded bore (16).

Once assembled the adjustable headspace gauge (10-17) is inserted into the rifle chamber (3) and the bolt (1) is closed, see FIG. 5. If the bolt (1) closes fully without resistance then the bolt (1) is opened, the adjustable headspace gauge (10-17) is removed from the chamber (3), and the modified cap screw (11) is rotated to increase the distance (15) between the feature that interfaces with the bolt face (12) and the feature that interfaces with the breeching feature of the chamber (14). If the bolt (1) did not close fully then the bolt (1) is opened, the adjustable headspace gauge (10-17) is removed from the chamber (3), and the modified cap screw (11) is rotated to decrease the distance (15) between the feature that interfaces with the bolt face (12) and the feature that interfaces with the breeching feature of the chamber (14). The adjustable headspace gauge (10-17) is reinserted into the chamber (3) and the ability to fully close the bolt (1) is retested after which the adjustable headspace gauge (10-17) is removed and adjusted as before. This sequence is repeated until the bolt (1) closes fully but with a small amount of interference being felt. When this occurs the distance (15) between the feature that interfaces with the bolt face (12) and the feature that interfaces with the breeching feature of the chamber (14) is the same as the distance (5) between the bolt face (2) and the breeching feature of the chamber (4). The adjustable headspace gauge (10-17) is removed from the chamber (3) and the setscrew (17) is tightened against the threaded stem (13) which locks the body (10) and the modified cap screw (11) together thereby fixing the distance (15) between the feature that interfaces with the bolt face (12) and the feature which interfaces with the breeching feature of the chamber (14). This distance (15) is then measured with tools that those of ordinary skill in the art of gunsmithing are very familiar with whereby the distance (5) between the bolt face (2) and the breeching feature of the chamber (4) is determined, this distance (5) being the headspace dimension.

An alternate embodiment of the invention (18-23) replaces the threaded bore (16) with a smooth bore (23) and replaces the modified cap screw (11) with a plug (19) having a smooth stem (21). The diameter of the bore (23) and the diameter of the stem (21) are carefully sized to provide a sliding fit connection, where the stem (21) can be pressed into and out of the bore (23) with a small force sufficiently large that the stem (21) does not move in the bore (23) when being handled. The alternate embodiment of the adjustable headspace gauge (18-23) is assembled by inserting the stem (21) of the plug (19) into the bore (23) of the body (18).

The alternative embodiment of the adjustable headspace gauge (18-23) would be used by extending it to it's maximum length, placing it in the chamber (3), and then closing the bolt (1) which would cause the bolt face (2) to press against the feature that interfaces with the bolt face (20) thereby pressing the stem (21) into the bore (23). The adjustable headspace gauge (18-23) would then be removed from the chamber (3) and the distance between the feature that interfaces with the bolt face (20) and the feature that interfaces with the breeching feature of the chamber (22) would be measured, this distance being the same as the headspace dimension of the chamber (5). This embodiment would be more convenient to use but the manufacturing tolerances that would be required for the diameters of the bore (23) and stem (21) to achieve the proper fit would likely make this embodiment (18-23) more costly that the primary embodiment (10-17).

Embodiments of an adjustable headspace gauge for the three other cartridge types (those having a rim, belt, or mouth as the breeching feature) would be designed similar to the embodiments presented above. Those of ordinary skill in the art of gunsmithing are readily capable of extending the primary design elements of the embodiments of the invention illustrated and discussed in this disclosure to these other cartridge types; those design elements being 1) a gauge feature that interfaces with the bolt face (2), 2) a gauge feature that interfaces with the breeching feature in the chamber, and 3) a threaded or sliding connection between these two gauge features.

I claim:

1. A gauging instrument for measuring the headspace dimension of a rifle, said rifle comprising a bolt and a chamber, said bolt having a face, said chamber having a breeching feature, said headspace dimension being the distance between said face of said bolt and said breeching feature of said chamber of, said gauging instrument comprising:
a feature which interfaces with said face of said bolt, and
a feature which interfaces with said breeching feature of said chamber,
said feature which interfaces with said face of said bolt and said feature which interfaces with said breeching feature of said chamber being joined by a threaded connection,
the distance between said feature which interfaces with said face of said bolt and said feature which interfaces with said breeching feature of said chamber being adjusted by rotating said threaded connection.

2. A gauging instrument for measuring the headspace dimension of a rifle, said rifle comprising a bolt and a chamber, said bolt having a face, said chamber having a breeching feature, said headspace dimension being the distance between said bolt face of said rifle and said breeching feature of said chamber of said rifle, said gauging instrument comprising:
a feature which interfaces with said face of said bolt, and
a feature which interfaces with said breeching feature of said chamber,
said feature which interfaces with said face of said bolt and said feature which interfaces with said breeching feature of said chamber being joined by a sliding connection,
the distance between said feature which interfaces with said face of said bolt and said feature which interfaces with said breeching feature of said chamber being adjusted by extending or compressing said sliding connection.

3. A method for measuring the headspace dimension of the chamber of a rifle, said rifle comprising a bolt and a chamber, said bolt having a face, said chamber having a breeching feature, said headspace dimension being the distance between said bolt face of said rifle and said breeching feature of said chamber of said rifle, said method comprising:
assembling a headspace gauge,
said headspace gauge comprising a feature which interfaces with said face of said bolt,
said headspace gauge further comprising a feature which interfaces with said breeching feature of said chamber,
the distance between said feature which interfaces with said face of said bolt and said feature which interfaces with said breeching feature of said chamber being adjustable;
adjusting the distance between said feature of said headspace gauge which interfaces with said face of said bolt and said feature of said headspace gauge which interfaces with said breeching feature of said chamber such that said bolt will fully close without resistance when said headspace gauge is placed inside said chamber;
increasing the distance between said feature of said headspace gauge which interfaces with said face of said bolt and said feature of said headspace gauge which interfaces with said breeching feature of said chamber in small increments until a small force is required to fully close said bolt when said headspace gauge is placed inside said chamber;
and measuring the distance between said feature of said headspace gauge which interfaces with said face of said bolt and said feature of said headspace gauge which interfaces with said breeching feature of said chamber.

4. A method for measuring the headspace dimension of the chamber of a rifle, said rifle comprising a bolt and a chamber, said bolt having a face, said chamber having a breeching feature, said headspace dimension being the distance between said bolt face of said rifle and said breeching feature of said chamber of said rifle, said method comprising:
assembling a headspace gauge,
said headspace gauge comprising a feature which interfaces with said face of said bolt,
said headspace gauge further comprising a feature which interfaces with said breeching feature of said chamber,
the distance between said feature interfacing with said face of said bolt and said feature interfacing with said breeching feature of said chamber being changed by a compressive force;
placing said headspace gauge into said chamber;
closing said bolt,
said closing action compressing said headspace gauge thereby changing the distance between said feature interfacing with said face of said bolt and said feature interfacing with said breeching feature of said chamber;
opening said bolt;
removing said headspace gauge from said chamber;
and measuring the distance between said feature of said headspace gauge interfacing with said face of said bolt and said feature of said headspace gauge interfacing with said breeching feature of said chamber.
